(19) United States
(12) Patent Application Publication
(10) Pub. No.: US 2013/0332754 A1
(43) Pub. Date: Dec. 12, 2013

(54) DATA STORAGE SYSTEM ENERGY AUDIT

(71) Applicant: Neal Downey, Longmont, CO (US)

(72) Inventor: Neal Downey, Longmont, CO (US)

(73) Assignee: Spectra Logic Corporation, Boulder, CO (US)

(21) Appl. No.: 13/490,669

(22) Filed: Jun. 7, 2012

(51) Int. Cl. G06F 1/32

(52) U.S. Cl. 713/320

(57) ABSTRACT

An apparatus and associated methodology for a data storage system having an enclosure containing a plurality of drives that are individually selectable to transfer data corresponding to an execution of input/output (I/O) commands between the data storage system and another device. A memory in the enclosure temporarily stores unexecuted I/O commands, and a power supply device is capable of simultaneously operating all of the plurality of drives in support of multiple transfers of data. A power management device operably reduces a power output of the power supply device in response to a forecasted interruption in the transfer of data with one of the drives at a time when an unexecuted I/O command for the one of the drives resides in the memory.

### FIELD

The present embodiments relate generally to auditing the power consumption in a data storage system as individual utilizations of data storage elements vary and more particularly, but without limitation, to reducing the power output of a power supply unit during intermittent delays in data transfer processing with the selected storage elements.

### BACKGROUND

The combination of multiple storage devices into distributed data storage capacity has proliferated in response to market demands that enormous amounts of data be readily available in a fast, reliable, and efficient manner. Although types of individual storage elements vary, some things are common like electrical components that not only advantageously perform desired functionalities but also consume significant amounts of energy and generate heat. Typically, multiple storage element arrays require some type of cooling devices, from simple fans to complex refrigeration cooling systems, to remediate the thermal load.

With continued demands for ever increased levels of storage capacity and performance, there remains an ongoing need for improvements in the manner in which the storage elements in such data storage arrays are operationally powered to optimize energy usage and heat generation. It is to these and other improvements that preferred embodiments of the present invention are generally directed.

### SUMMARY

Some embodiments of the present invention contemplate a data storage system having an enclosure containing a plurality of drives that are individually selectable to transfer data corresponding to an execution of input/output (I/O) commands between the data storage system and another device. A memory in the enclosure temporarily stores unexecuted I/O commands, and a power supply device is capable of simultaneously operating all of the plurality of drives in support of multiple transfers of data. A power management device operably reduces a power output of the power supply device in response to a forecasted interruption in the transfer of data with one of the drives at a time when an unexecuted I/O command for the one of the drives resides in the memory.

Some embodiments of the present invention contemplate a method that includes: operating a data storage system having a plurality of drives that are individually selectable to transfer data corresponding to an execution of I/O commands between the data storage system and another device, a power supply device capable of simultaneously operating all of the plurality of drives in support of multiple data transfers of data, and a memory temporarily storing unexecuted I/O commands; forecasting an interruption in the transfer of data with one of the drives at a time when an unexecuted I/O command for the one of the drives resides in the memory; and in response to the forecasting, reducing a power output of the power supply device.

Some embodiments of the present invention contemplate a data storage library having a frame supporting a shelf system to queue a plurality of magazines and a plurality of tape cartridges each removably supported by one of the plurality of magazines. A plurality of drives is each adapted to engage one of the tape cartridges at a time in a data transfer relationship. A transport system selectively moves the tape cartridges between the queue in the shelf and the data transfer relationships in one of the plurality of drives. A memory within the frame temporarily stores I/O commands driving the data transfer relationships between each of the drives and the tape cartridges. A power supply device within the frame is capable of operating all of the plurality of drives simultaneously in support of the data transfer relationships. Computer code stored in memory is implemented to reduce a power output of the power supply device in response to a forecasted interruption in the data transfer relationship with one of the drives at a time when a pending I/O command for the one of the drives resides in the memory.

### BRIEF DESCRIPTION I/F THE DRAWINGS

FIG. 1 is a functional block depiction of a storage element array that is constructed in accordance with embodiments of the present invention.

FIG. 2 is a functional block depiction of a portion of the storage element array of FIG. 1.

FIG. 3 is a functional block depiction similar to FIG. 2 but depicting more particular embodiments of the present invention.

FIG. 4 is a functional block depiction similar to FIG. 3 but depicting more particular embodiments of the present invention.

FIG. 5 diagrammatically depicts a storage element array constructed as a tape library in accordance with embodiments of the present invention.

FIG. 6 is an isometric depiction of one of the magazines with tape cartridges in the tape library of FIG. 5.

FIG. 7 is a flowchart depicting steps for an ENERGY AUDIT method in accordance with embodiments of the present invention.

FIG. 8 is a functional block depiction of a portion of the storage element array of FIG. 4.

FIG. 9 is a functional block depiction of the mapping of forecasted drive utilization performed in accordance with embodiments of the present invention.

FIG. 10 is a functional block depiction similar to FIG. 9 enabling one PSU to power portions of two different predefined sets of drives.

FIG. 11 is an isometric depiction of a portion of a tape library constructed in accordance with illustrative embodiments of the present invention.

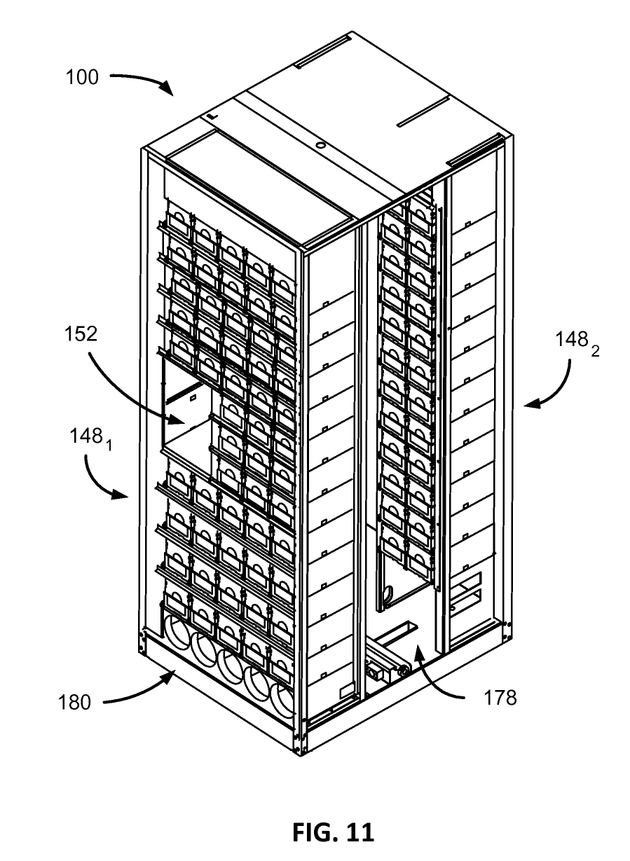

### DETAILED DESCRIPTION

Initially, it is to be appreciated that this disclosure is by way of example only, not by limitation. The energy audit concepts herein are not limited to use or application with any specific system or method for using storage element devices. Thus, although the instrumentalities described herein are for the convenience of explanation, shown and described with respect to exemplary embodiments, it will be appreciated that the principles herein may be applied equally in other types of storage element systems and methods involving the storage and retrieval of data.

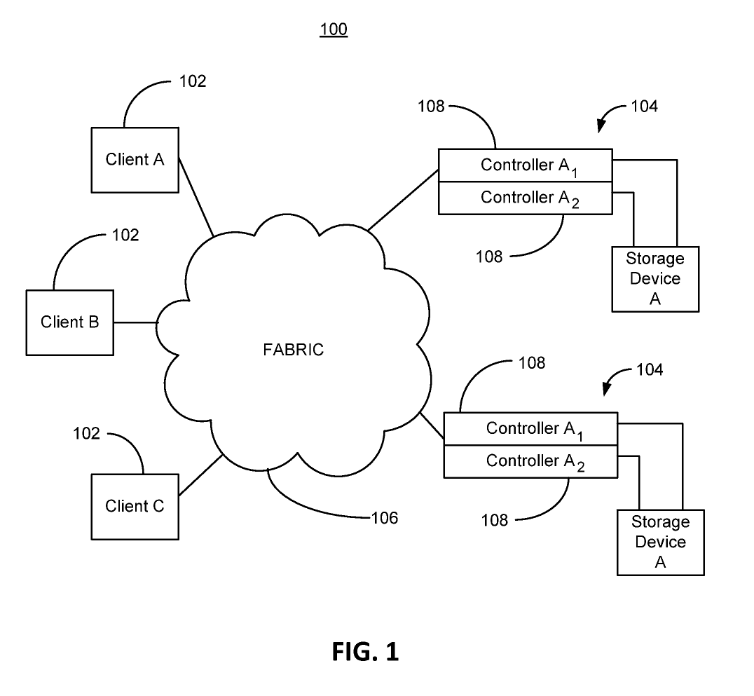

To illustrate an exemplary environment in which preferred embodiments of the present invention can be advantageously practiced, FIG. 1 shows a data storage system 100 characterized as providing a storage area network (SAN) utilizing mass storage. The system 100 includes a number of processing client devices 102, respectively identified as clients A, B, and C. The clients 102 can interact with each other as well as with a pair of data storage arrays 104 (denoted A and B, respectively) via a fabric 106. The fabric 106 is preferably characterized as fibre-channel based switching network, although other configurations can be utilized as well, including the Internet. Data is transferred between the clients 102 and the storage arrays 104 by executing input/output (I/O) commands. Generally, an I/O command can originate from either a client 102 or a storage array 104 to store data to or retrieve previously stored data from a storage array 104.

Each array 104 preferably includes a pair of controllers 108 (denoted A1, A2 and B1, B2) for redundancy sake, and a set of data storage devices 110. It is further contemplated that in some embodiments the A client 102 and the A data storage array 104 can be physically located at a first site, the B client 102 and B storage array 104 can be physically located at a second site, and the C client 102 can be yet at a third site, although such is merely illustrative and not limiting.

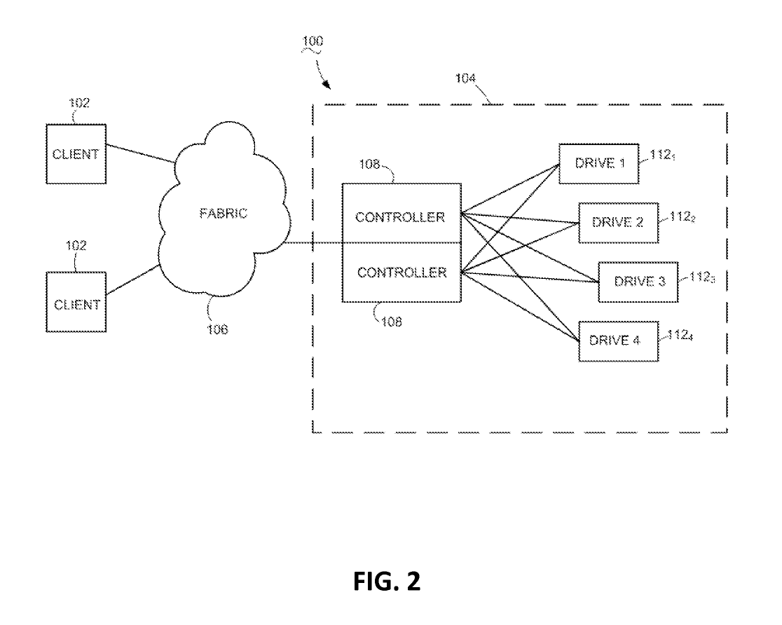

FIG. 2 diagrammatically depicts illustrative embodiments of the data storage system 100 in which one of the arrays 104 is connected to the clients 102 to transfer data with a number of drives 112 that are individually selectable to transfer the data by executing the I/O commands via the switchable fabric 106. In these illustrative embodiments each of the remote clients 102 can view the entire physical storage capacity (via the drives 112) of the array 104 as a unified storage space. The array 104, the client 102, or a network appliance (not shown) virtualizes the physical storage space to a logical addressing nomenclature. The array 104 also buffers data being transferred between the clients 102 and the drives 112 to optimize I/O throughput performance, such as by employing writeback commands that temporarily store transfer data and acknowledge the write as being complete before that transfer data is actually stored via the drives 112. The array 104 can also advantageously employ predetermined fault tolerance arrangements in which parallel, redundant links store at least some of the transfer data so that a redundant copy of the transfer data can be retrieved or reconstructed in the event that the primary copy of the transfer data becomes unavailable.

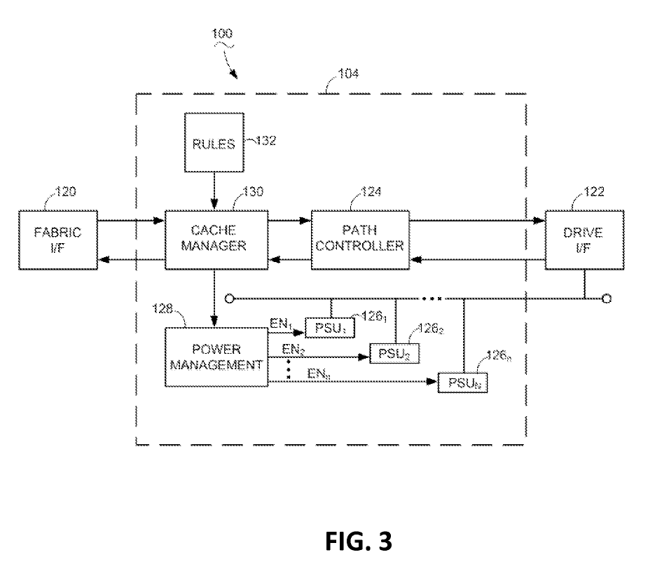

FIG. 3 is a functional block depiction of pertinent portions of the storage array 104. Each of the circuitries associated with the depicted functions here and throughout this description generally can be embodied in a single integrated circuit or can be distributed among a number of discrete circuits as desired. A main processor 114, preferably characterized as a programmable computer processor, provides top-level control in accordance with programming steps and processing data stored in non-volatile memory (such as flash memory or similar) and in dynamic random access memory (DRAM). A memory, such as the cache 116, temporarily stores unexecuted I/O commands and corresponding transfer data until such a time that they are executed to effect the transfer of the data via the drives 112. A power controller controls the power output mode of one or more power supply units (PSUs) powering each of the drives 112, as described below.

A fabric interface (I/F) 120 communicates with the dual controllers 108 and the clients 102 via the fabric 106, and a drive I/F 122 communicates with the drives 112. The I/F circuits 120, 122 and a path controller 124 form a pass-through communication path for commands and data between the storage array 104 and the client(s) 102, such as by employing the cache memory 116. Again, although illustrated discretely, it will be understood that each path controller 124 and the corresponding I/F circuits 120, 122 can be unitarily constructed.

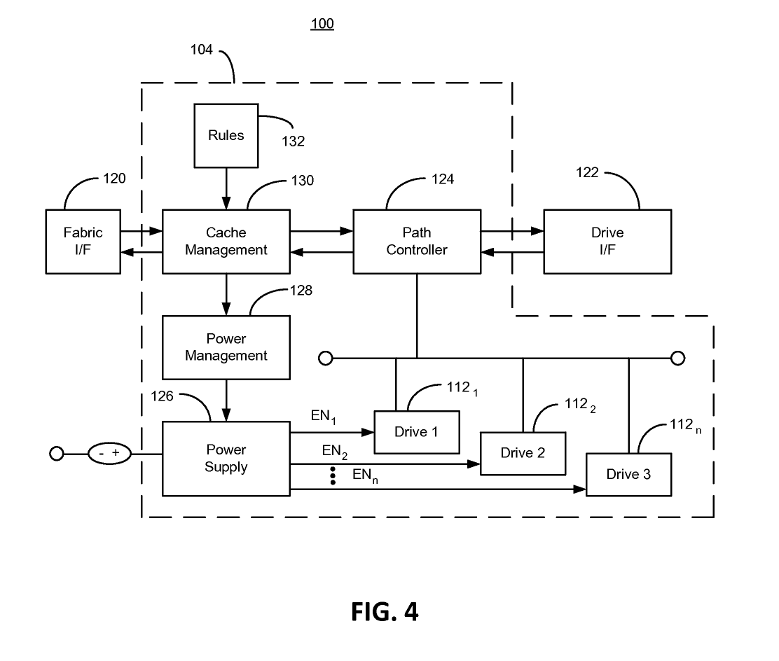

FIG. 4 is a functional block depiction of pertinent portions of an illustrative array 104 constructed in accordance with further more particularly described embodiments of the present invention. A power management device 128 is responsive to the status of a cache manager 130 in selectively sending power mode enable (EN) signals individually controlling a plurality of PSUs 126₁, 126₂, . . . 126ₙ. Each of the PSUs 126 is sized so as to be capable at a maximum output capability of simultaneously operating all of a predetermined plurality of the drives 112₁, 112₂, . . . 112ₙ in support of multiple transfers of data corresponding to execution of the I/O commands. For purposes of the description that follows each PSU 126 is sized to simultaneously operate up to four drives 112, although that is merely illustrative and not limiting of the contemplated embodiments. That is, in equivalent alternative embodiments each PSU 126 can be sized so that at a maximum power output mode it can simultaneously operate any number of the drives 112.

The power management device 128 advantageously reduces the power output of the PSU 126 when one or more of the drives 112 is predictably not being utilized or is being utilized in a way resulting in a reduced power consumption. For example, the power management device 128 executes computer instructions stored in memory to recognize a forecasted interruption in the respective transfer of data with a selected one or more of the drives 112₁, 112₂, . . . 112ₙ at a time when it is also known from the cache manager 130 that ultimately, after the interruption, I/O command processing with the selected one or more drives 112₁, 112₂, . . . 112ₙ will resume. An indication that I/O command processing with the selected one or more drives 112₁, 112₂, . . . 112ₙ will ultimately resume can be that an unexecuted I/O command for the selected one or more drives 112₁, 112₂, . . . 112ₙ resides in the cache 116 (FIG. 3) at the time of the interruption of the transfer of data.

The total number of drives 112 that are powered up at any given time can be parametrically determined in a way that optimizes data throughput and power usage. For an extreme example, if there is only one pending I/O command in cache 116 it would be a waste of energy, and concomitant needless excess generated heat, to power more than one drive 112 to execute that one pending I/O command. In that event the PSU 126 can be derated to output only enough power to operate the one drive 112 in accordance with embodiments of the present invention.

In that same vein of reasoning, if some data transfers can be delayed to an off-peak time, such as during the middle of the night, then it can be acceptable to execute those I/O commands at a slower data throughput rate than what is required during the normal office hours when users otherwise expect data transfers to occur as instantly as possible. For example, where redundant storage methodologies are employed such as a redundant array of independent tapes (RAIT), redundant copies of primary data can at least to some extent be held in a nonvolatile memory in the array 104 and transferred via the drives 112 during off-peak operational time periods. Ultimate control of time shifting of the I/O command load can be governed by rules 132 that can be empirically derived by characterizing the I/O command load over time, and/or the rules 132 can be user-defined by a graphical user interface allowing the user to set and adjust the governing parameters.

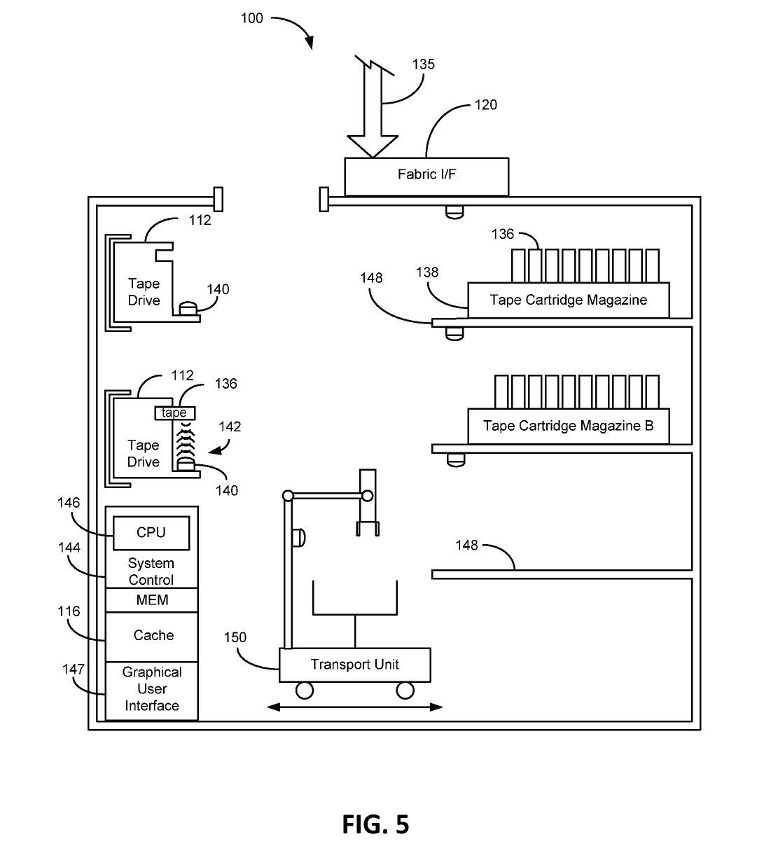

FIG. 5 diagrammatically depicts the array 104 constructed as a tape library 134 in accordance with illustrative embodiments of the present invention. External communications for the transfers of data corresponding to the I/O commands is performed via the fabric interface 120 coupled to a communications link 135. The number and arrangement of the various components depicted in FIG. 5 are merely illustrative and in no way limiting of the claimed invention. The tape library has a plurality of tape cartridges 136 grouped in magazines 138. Each of the tape cartridges 136 is identifiable, such as by radio frequency identification (RFID) tags or semiconductor memory devices and the like, for selectively loading a desired one of the tape cartridges 136 into one of the plurality of drives 112. These illustrative embodiments depict the usage of a semiconductor memory in the form of a medium auxiliary memory (“MAM”) device for this purpose, as discussed in more detail below. Again, these described embodiments in which the data storage device is a tape cartridge 136 and the drives 112 are tape drives are merely illustrative and not limiting of the claimed embodiments. For example, without limitation, in equivalent alternative embodiments the drives can be configured to transfer data with other types of removable data storage devices, and in other equivalent alternative embodiments the drives can contain nonremovable data storage devices such as hard disc drives and solid state drives and the like.

Each of the tape cartridges 136 is selectively loadable into one of the drives 112 to cooperatively form an operable data transfer relationship to store data to and/or retrieve data from the tape cartridge 136. Each drive 112 can have a MAM device reader/writer 140 to store data to and/or retrieve data from the MAM device. In these illustrative embodiments the drive 112 establishes wireless communications 142 with the MAM device, such as by radio frequency communication, although neither the disclosed embodiments nor the claimed embodiments are so limited to those illustrative embodiments. The MAM device data can advantageously include access occurrence data, such as timestamp data indicating when the tape cartridge 136 is loaded in a drive 112, load count data indicating how long a tape cartridge 136 is loaded in the drive 112, validity data indicating any data and/or portions of the storage medium in a tape cartridge 136 of questionable integrity, and the like. Besides, or in addition to, storing data on the MAM devices, a larger system memory 144 can accommodate information, such as the access occurrence data, load data, validity data, and the like, from each of a plurality of MAM devices associated with respective tape cartridges 136. Computational routines on the data stored in the MAM devices and in the system memory 144 can be under the top-level control of a central processing unit (“CPU”) 146. A graphical user interface (“GUI”) 147 provides helpful tabular and graphical information to a user of the tape library for providing inputs thereto and receiving useful outputs therefrom.

The tape library can advantageously have a shelving system 148 capable of processor-based archiving the magazines 138 within the tape library. A transport unit 150 shuttles magazines 138 between the shelving system 148 and the drives 112, and picks and places a particular tape cartridge 136 from a shuttled magazine 138 to/from a desired drive 112. Again, although FIG. 5 diagrammatically depicts two magazines 138 of eleven tape cartridges 136 each being shuttled to and from two drives 112, that arrangement is merely illustrative and in no way limiting of the claimed embodiments. In any event, a desired number of drives 112 can be provided within the tape library to concurrently access a corresponding number of tape cartridges 136 in a storage element array 104, or two or more tape libraries can communicate with each other to form that same or a similar storage element array 104.

The tape library is not necessarily limited to using a fixed number of tape cartridges 136. Rather, an access port 152 is configured to cooperate with an external transport system (not shown) to deliver or remove individual tape cartridges 136 or magazines 138.

Top-level control is provided by the CPU 146 in communication with all the various components via a computer area network (not shown). Data, virtual mappings, executable computer instructions, operating systems, applications, and the like are stored to the system memory 144 and accessed by one or more processors in and/or under the control of the CPU 146. The CPU 146 includes macroprocessors, microprocessors, memory, and the like to logically carry out software algorithms and instructions.

As one skilled in the art will recognize, the illustration of the tape library in FIG. 5 diagrammatically depicts only major elements of interest for purposes of simplicity. As such, certain necessary structures and components for the aforementioned elements to properly function are omitted from the detailed description, the enumeration of such not being necessary for the skilled artisan to readily ascertain the enablement of this description and the scope of the claimed subject matter. For example, it will be understood that the tape library includes all of the necessary wiring, user interfaces, plugs, modular components, entry and exit port(s) to introduce (or remove) removable storage elements, fault protectors, power supplies, processors, busses, robotic transport unit tracks, indication lights, and so on, in order to carry out the function of a tape library.

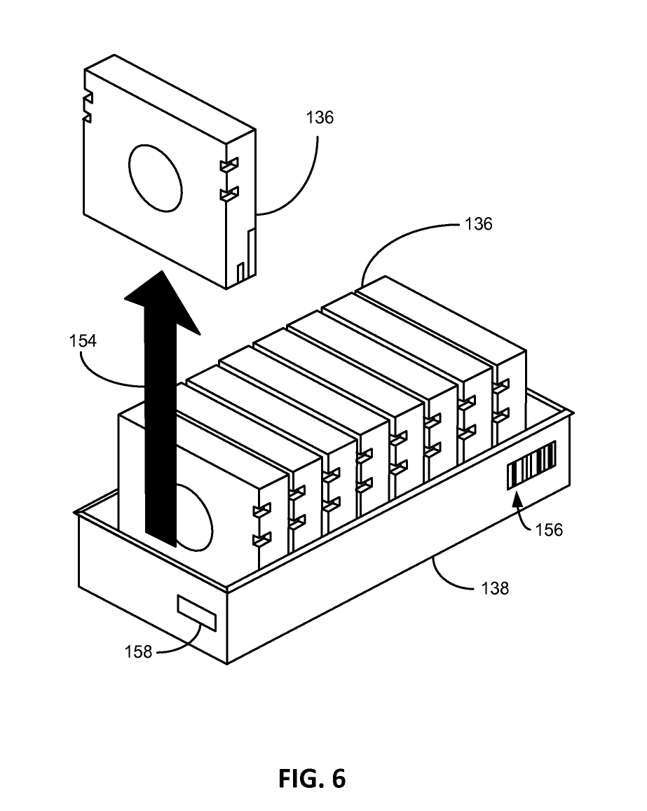

FIG. 6 depicts the tape cartridges 136 supported for storage and transit by the magazine 138. In more detail, the tape cartridge 136, such as an LTO-3 category tape cartridge manufactured by IBM, of Armonk, N.Y., employs magnetic tape that is capable of storing digital data written by the drive 112. The magazine 138 is depicted as being populated with a plurality of the tape cartridges 136, each of which can be removed upwardly by the transport unit 150 (FIG. 5), in the direction of arrow 154, then inserted into the drive 112. An indicia such as a bar code identification tag 156 is one way of identifying the magazine 138. Additionally, these embodiments depict a MAM device 158 attached to the magazine 138 and associated with one or more, preferably all, of the tape cartridges 136 residing in the magazine 138. Alternatively, the MAM device 158 can be attached to the tape cartridge 136. The MAM device 158 can be a passive device that is energized when subjected to a sufficiently strong radio frequency field generated by the MAM writer/reader device 140 (FIG. 5).

In the tape library of FIG. 5 the power management device 128 (FIG. 4) monitors when all of the pending I/O commands for a particular tape cartridge 136 in one of the drives 112 have been executed, so that as a result that particular tape cartridge 136 is swapped out for another tape cartridge 136 for which pending I/O commands do reside in cache 116. For example, without limitation, the power management device 128 can observe when the path controller 124 commands that an existing tape cartridge 136 in a selected one of the drives 112 be swapped for another tape cartridge 136. That command is necessarily associated with some delay associated with the interval of time necessary for the transport unit 150 to remove the existing tape cartridge 136ₓ, retrieve the replacement tape cartridge 136_{y}, and operably mount the replacement tape cartridge 136_{y} in the data transfer relationship with the selected drive 112. During that delay (when not tape is mounted) the selected drive 112 is inoperable for its purpose of transferring data associated with the pending I/O commands in the cache 116. Calculating that interval of time associated with swapping out the existing tape cartridge 136ₓ in a selected drive 112 for another tape cartridge 136_{y} quantifies the forecasted interruption in the data transfer relationship with the selected drive 112.

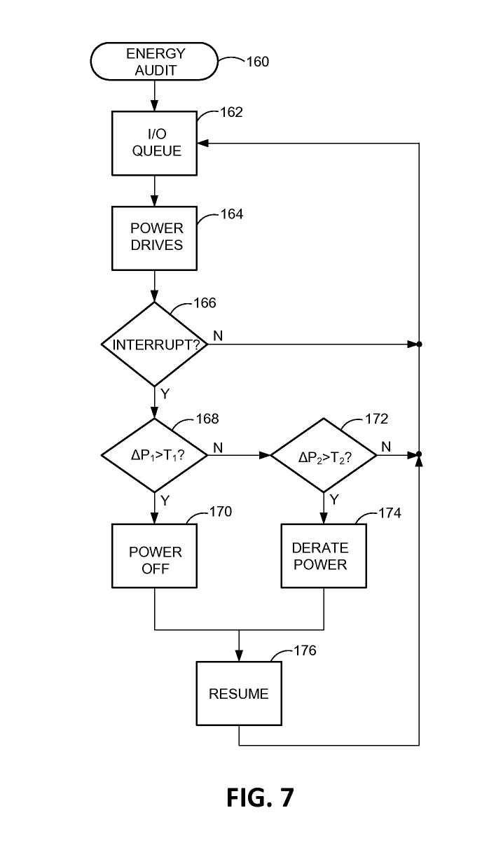

FIG. 7 is a simplified flowchart depicting generalized steps in an ENERGY AUDIT method 160 in accordance with illustrative embodiments of the present invention. The method 160 begins in block 162 with the power management device monitoring the status of one or more queues of pending I/O commands in cache, and then in block 164 powering the number of drives necessary to support the I/O command load with a predetermined data throughput performance. The number of powered up drives can be varied within certain predefined parametric constraints to optimize both throughput and required power, as discussed above.

In block 166 it is determined whether any forecast exists of an upcoming interruption of data transfer capability with a drive, such as due to the need to change out a tape cartridge in a selected drive with another tape cartridge as discussed. If the determination of block 166 is “no,” then control returns to block 162 for further execution of the pending I/O commands. If, however, the determination of block 166 is “yes,” then in block 168 the power management device converts the forecasted interruption to a power savings value calculated in terms of operating the PSU during at least a portion of the interruption at a reduced power output level. For example, without limitation, the power management device can calculate the power savings resulting from operating the PSU at a predetermined reduced power mode, producing less power than the maximum output mode but nonetheless making the drive fully capable of all operations necessary to change out the existing tape cartridge with another tape cartridge. In equivalent alternative embodiments the power management device can calculate the reduced power mode in terms of even lower predetermined power output modes such as a minimal output sleep mode or even a power off mode. Generally, the more power savings that are gained from the reduced power mode, the longer will be the recovery period for returning the drive to data transfer duty after the replacement tape is mounted.

In block 168 the power management device then compares the calculated power savings value ΔP₁ to a predetermined first threshold value T₁. If the power savings value is greater than the first threshold value then the power management device reduces the power output mode of the PSU to the predetermined reduced power mode in block 170, such as the power-off mode depicted, for an interval of time associated with the forecasted interruption. Preferably, the interval of time during which the power supply is operated at the reduced power mode is correlated to the forecasted interruption duration so that the PSU is returned to the appropriate operational capability before the replacement tape is fully made ready to transfer data again. For that purpose it can be advantageous to calculate the power saving mode in terms of a fractional portion of the interruption duration, either empirically or manually set and/or adjusted, such as calculating the power savings value over 90% of the entire interruption interval.

If, on the other hand, the comparison in block 168 concludes that the power savings value is not greater than the first threshold, then control passes to block 172 where the power management device converts the forecasted interruption to a second power savings value different than the first. The second power savings value is also a reduced power mode, but one that produces comparatively more power than the other reduced power mode for which the first power savings was calculated. For example, without limitation, in the illustrative embodiments of FIG. 7 the second power savings value ΔP₂ is calculated in relation to derating the PSU to operate less than the maximum number of drives. Again, however, these depicted embodiments are merely illustrative and in no way limiting of all claimed embodiments that can include any number and type of reduced power modes in accordance with the methodology, as the skilled artisan will appreciate.

In block 172 the power management device then compares the calculated power savings value ΔP₂ to a predetermined second threshold value T₂. If the power savings value is greater than the second threshold value then the power management device derates the PSU to the reduced power mode in block 174 for an interval of time associated with the interruption. As above, the interval of time during which the PSU is operated at the reduced power mode is preferably correlated to the forecasted interruption duration so that the PSU is returned to full operational capability before the replacement tape is made fully ready to transfer data again; such as calculating the power savings value over 90% of the entire interruption interval. In either event, when the replacement tape is ready in block 176 the power management device resumes power control post-interruption by control looping back to block 162 and the process continuing.

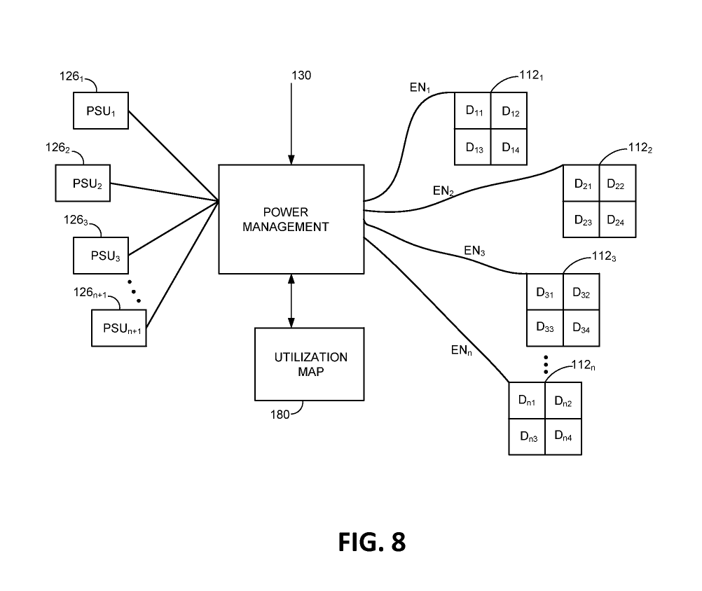

FIG. 8 diagrammatically depicts embodiments of the present invention in that the power management device and corresponding logic enables an optimal number and output rating of the PSUs 126 for the continuously changing power consumption demands of a plurality of the drives 112. Again, in these illustrative embodiments each PSU 126 is sized to simultaneously operate up to four drives 112. Accordingly, in these depicted embodiments the power management device 128 has enabled PSU₁ at maximum output power capacity via EN₁ to supply power to each of the plurality of drives D₁₁, D₁₂, D₁₃, D₁₄. The power management device 128 can enable any one of the PSUs 126 to power any of the pluralities of drives 112. For example, the power management device 128 can alternatively enable the PSU₁ to power the plurality of drives D₂₁, D₂₂, D₂₃, D₂₄. Preferably, a power system backup redundancy is provided by having “N+1” number of PSUs 126 available to the power management device 128 for selectively powering “N” pluralities of the drives 112, such as the six pluralities of drives 112 that are powered by selectively enabling the seven PSUs 126.

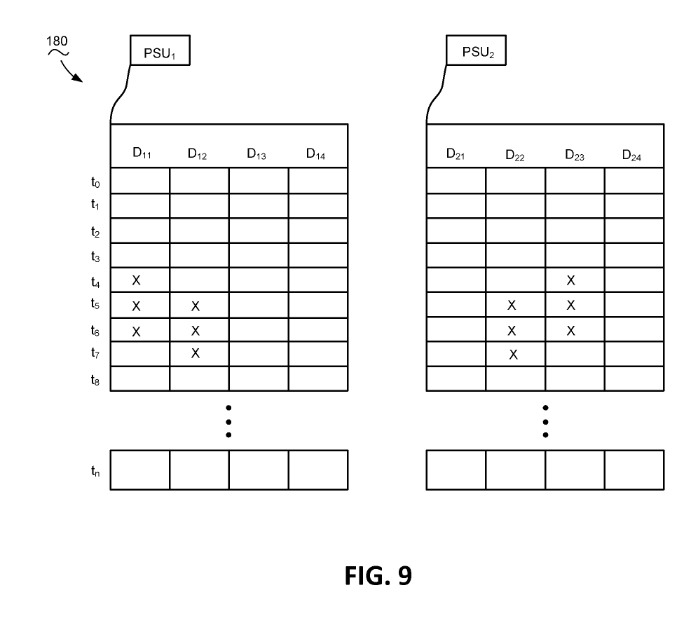

As discussed previously, the power management device 128 has visibility of the I/O load from the cache manager 130. The power management device 128 correlates one or more command queues of the I/O commands to the corresponding drives 112 to which they are related to produce a map 180 of an ongoing forecast of the utilization of each drive 112. For example, FIG. 9 depicts a portion of the map 180 for each of two pluralities of the drives 112₁ (D₁₁, D₁₂, D₁₃, D₁₄) and 112₂ (D₂₁, D₂₂, D₂₃, D₂₄) for each interval of future time t₁, t₂, . . . tₙ. It will be further noted that in FIG. 9 the power management device 128 has enabled PSU₁ to fully power all four drives D₁₁, D₁₂, D₁₃, D₁₄ and has enabled PSU₂ to fully power all four drives D₂₁, D₂₂, D₂₃, D₂₄ as is required at t₀.

The map 180 depicts by “Xs” those intervals of time during which an interruption is forecast to occur with one of the drives 112, such as during the time that a tape cartridge is switched out as discussed before. For example, the map 180 informs the power management device 128 that such an interruption will occur with drive D₁₁ during the time interval t₄-t₆. The power management device 128 can calculate the power savings potential as discussed above from derating PSU₁ from an output capacity of four drives 112 to a lower predetermined output capacity of only the three drives (D₁₂, D₁₃, D₁₄) that will be required during t₄, and the further power savings potential to an even lower predetermined output capacity of two drives (D₁₃, D₁₄) that will be utilized in the set of drives 112₁ during t₅-t₆.

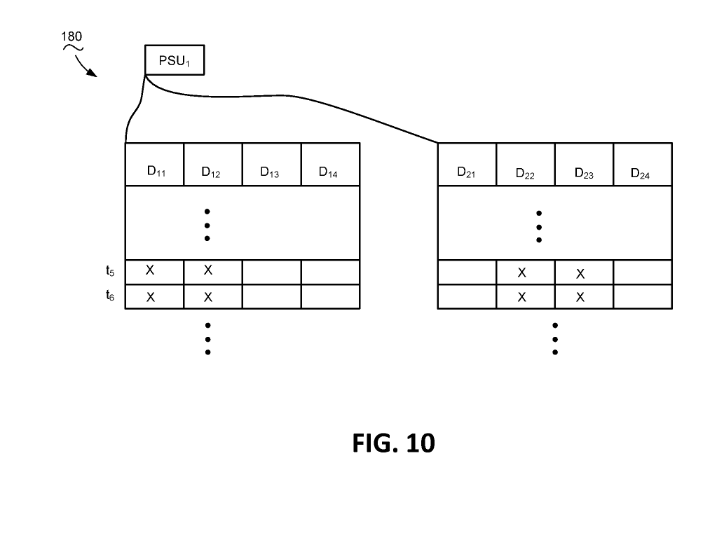

The power management device 128 performs the same power savings potential analysis for the other set of drives 112₂ which likewise only needs to power two drives (D₂₁, D₂₄) during the interval t₅-t₆. In some embodiments, where the power savings threshold analysis is satisfied, the power management device 128 can derate both PSU1 and PSU2 from maximum power output to a predetermined reduced power mode for powering only two drives 112 instead of four drives 112. However, in the event that each PSU operates most efficiently at maximum output load then the power management device 128 powers off one of the two PSUs in this case and enables the other PSU, such as PSU₁ depicted in FIG. 10, to power all four of the utilized drives D₁₃, D₁₄, D₂₁, D₂₄ in the two sets of drives 112₁, 112₂ during the interval of time t₅-t₆. In other equivalent alternative embodiments the power management device 128 can combine more than two set of drives 112, such as but not limited to powering only one drive utilized for a forecasted interval of time in each of four different pluralities of the drives 112.

The example above that each PSU operates most efficiently at maximum loading is illustrative and not limiting of the contemplated embodiments of this invention. Generally, the loading at which any particular PSU operates most efficiently will either be known from the manufacturer's specifications or it can be empirically determined by measuring the ratio of input power (Pᵢₙ) to output power (Pₒᵤₜ) over the range of possible different loadings. If, for example in alternative equivalent embodiments, the PSU is known or observed to be most efficient when powering three of the four drives (¾ loading), then the power supplies would be managed as above but for aiming to keep all the powered PSUs operating at ¾ load for maximum operating efficiency.

Embodiments of the present invention can be commercially practiced in a Spectra Logic T-950 tape library manufactured by Spectra Logic of Boulder Colo. FIG. 9 shows a commercial embodiment of one T-950 tape library without an enclosure. The T-950 tape library comprises a first and second shelf system 148₁, 148₂ that are adapted to support a plurality of the mobile media, such as the magazine 138 holding a plurality of LTO-3 tape cartridges 136 with MAMs, archived by the tape library. The shelf systems 148₁, 148₂ can each have at least one auxiliary memory reader. Disposed next to the second shelf system 148₂ are at least four IBM LTO-3 tape drives 112 adapted to write data to and read data from a tape cartridge 136. The IBM LTO-3 tape drives 112 each have the capability of storing data to an auxiliary radio frequency memory device contained in an LTO-3 tape cartridge 136. Functionally interposed between the first and second shelf system 148₁, 148₂ is a magazine transport space 178. The magazine transport space 178 is adapted to provide adequate space for a magazine 138 to be moved, via the transport unit 150 (FIG. 5), from a position in the first shelf system 148₁, for example, to a tape drive 112. The transport unit 150 can further accommodate at least one auxiliary radio frequency memory device reader. Magazines 138 can be transferred into and out from the T-950 tape library via the entry/exit port 152. Transferring magazines 138 in and out of the T-950 tape library can be accomplished by an operator, for example. The T-950 tape library comprises a means for cooling as shown by the fans 180, located at the base of the tape library. The T-950 tape library can be linked to a central data base, providing control in storage of all of the auxiliary radio frequency memory devices contained in each tape cartridge 136 in the T-950 tape library as read by any one of the auxiliary radio frequency memory device readers. The T-950 tape library also includes the library CPU 146 (FIG. 5) providing top-level control and coordination of all processes. The T-950 tape library also provides the graphical user interface 147 (FIG. 5) whereon a display of assessment results or, in alternative embodiments, simple messages can be displayed pertaining to a user-specified action associated with a tape cartridge 136 such as an alert accompanying a sound alarm or recommendations for further action/s, for example.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, multiple or even predetermined pluralities of tape drives can be managed in the energy audit process for example, while still maintaining substantially the same functionality without departing from the scope and spirit of the claimed invention. Another example can include using these techniques across multiple library partitions, while still maintaining substantially the same functionality without departing from the scope and spirit of the claimed invention. Further, though communication is described herein as between a client and the library communication can be received directly by a tape drive, via the interface device 120, for example, without departing from the scope and spirit of the claimed invention. Further, for purposes of illustration, a first and second tape drive and tape cartridges are used herein to simplify the description for a plurality of drives and tape cartridges. Finally, although the preferred embodiments described herein are directed to tape drive systems, and related technology, it will be appreciated by those skilled in the art that the claimed invention can be applied to other systems, without departing from the spirit and scope of the present invention.

It will be clear that the claimed invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the claimed invention disclosed and as defined in the appended claims.

It is to be understood that even though numerous characteristics and advantages of various aspects have been set forth in the foregoing description, together with details of the structure and function, this disclosure is illustrative only, and changes may be made in detail, especially in matters of structure and arrangement to the full extent indicated by the broad general meaning of the terms in which the appended claims are expressed.

What is claimed is:

1. A data storage system comprising:
an enclosure containing a plurality of drives that are individually selectable to transfer data corresponding to an execution of input/output (I/O) commands between the data storage system and another device;
a memory in the enclosure temporarily storing unexecuted I/O commands;
a power supply device capable of simultaneously operating all of the plurality of drives in support of multiple transfers of data; and
a power management device that operably reduces a power output of the power supply device in response to a forecasted interruption in the transfer of data with one of the drives at a time when an unexecuted I/O command for the one of the drives resides in the memory.

2. The data storage system of claim 1 wherein the plurality of drives transfers data with the another device via a network.

3. The data storage system of claim 1 wherein the power management device quantifies the forecasted interruption in terms of an interval of time required to change out a removable data storage device with the one of the drives.

4. The data storage system of claim 3 wherein the power management device converts the forecasted interruption to a power savings value calculated in terms of operating the power supply device during at least a portion of the interval of time at a predetermined reduced power output mode.

5. The data storage system of claim 4 wherein the power management device compares the power savings value to a predetermined threshold value.

6. The data storage system of claim 5 wherein the power savings value is characterized as a first power savings value and the reduced power output mode is characterized as a first reduced power mode, and wherein the power management device converts the forecasted interruption to a second power savings value calculated in terms of operating the power supply device during at least a portion of the interval of time at a second reduced power mode that is higher than the first reduced power mode.

7. The data storage system of claim 6 wherein the predetermined threshold value is characterized as a first threshold value, and wherein the power management device switches the power supply device to the second reduced power mode when the first power savings value is less than the first threshold value and the second power savings value is greater than a second predetermined threshold value.

8. The data storage system of claim 7 wherein the first reduced power mode is a power off mode.

9. The data storage system of claim 1 wherein the plurality of drives is characterized as a first plurality of drives and the power supply device is characterized as a first power supply device, the data storage system further comprising:
a second plurality of drives each individually selectable to transfer data corresponding to an execution of I/O commands between the data storage system and the another device;
a second power supply device capable of simultaneously operating all of the second plurality of drives in support of multiple transfers of data; and
the power management device operably reduces a power output of the second power supply device in response to a forecasted interruption in the transfer of data with one of the drives at a time when an unexecuted I/O command for the one of the drives resides in the memory.

10. The data storage system of claim 9 wherein a number of the plurality of drives is “N” and the number of power supply devices in “N+1.”

11. The data storage system of claim 9 comprising six pluralities, each of four drives, and seven power supplies.

12. The data storage system of claim 9 wherein the power management device can power the first plurality of drives with either the first power supply device or the second power supply device and can power the second plurality of drives with the other power supply device.

13. A method comprising:
operating a data storage system having a plurality of drives that are individually selectable to transfer data corresponding to an execution of I/O commands between the data storage system and another device, a power supply device capable of simultaneously operating all of the plurality of drives in support of multiple data transfers of data, and a memory temporarily storing unexecuted I/O commands;
forecasting an interruption in the transfer of data with one of the drives at a time when an unexecuted I/O command for the one of the drives resides in the memory; and
in response to the forecasting, reducing a power output of the power supply device.

14. The method of claim 13 wherein the forecasting is characterized by quantifying the forecasted interruption in terms of an interval of time required to change out a removable data storage device with the one of the drives.

15. The method of claim 14 wherein the forecasting is characterized by converting the forecasted interruption to a power savings value calculated in terms of operating the power supply device during at least a portion of the interval of time at a predetermined reduced power output mode.

16. The method of claim 15 wherein the reducing a power output mode is characterized by switching the power supply device to the reduced power consumption mode when the power savings value is greater than a predetermined threshold value.

17. The method of claim 16 wherein the power savings value is characterized as a first power savings value and the reduced power output mode is characterized as a first reduced power mode, and wherein the reducing a power output mode is characterized by converting the forecasted interruption to a second power savings value calculated in terms of operating the power supply device during at least a portion of the interval of time at a second reduced power mode that is higher than the first reduced power mode.

18. The method of claim 17 wherein the predetermined threshold value is characterized as a first threshold value, and wherein the reducing a power output mode is characterized by switching the power supply device to the second reduced power mode when the first power savings value is less than the first threshold value and the second power savings value is greater than a second predetermined threshold value.

19. The method of claim 13 wherein the operating is characterized by the plurality of drives being a first plurality of drives and the power supply device being a first power supply device, a second plurality of drives that are individually selectable to transfer data corresponding to an execution of I/O commands between the data storage system and the another device, a second power supply device capable of simultaneously operating all of the second plurality of drives in support of multiple transfers of data, and the reducing a power output is characterized by reducing to a predetermined power output mode of the second power supply device in response to a forecasted interruption in the transfer of data with one of the drives at a time when an unexecuted I/O command for the one of the drives resides in the memory.

20. The method of claim 17 wherein the first reduced power mode is a power off mode.

21. A data storage library comprising:
a frame;
a shelf system supported by the frame to queue a plurality of magazines;
a plurality of tape cartridges each removably supported by one of the plurality of magazines;
a plurality of drives each adapted to engage one of the tape cartridges at a time in a data transfer relationship;
a transport system selectively moving the tape cartridges between the queue in the shelf and the data transfer relationships in one of the plurality of drives;
a memory within the frame temporarily storing I/O commands driving the data transfer relationships between each of the drives and the tape cartridges;
a power supply device within the frame capable of operating all of the plurality of drives simultaneously in support of the data transfer relationships; and
computer code stored in memory that is implemented to reduce a power output of the power supply device in response to a forecasted interruption in the data transfer relationship with one of the drives at a time when a pending I/O command for the one of the drives resides in the memory.
